(19) United States
(12) Patent Application Publication
(10) Pub. No.: US 2025/0136166 A1
(43) Pub. Date: May 1, 2025

(54) CHILD-ACCOMMODATION DEVICE, IN PARTICULAR PRAM AND/OR CHILD SEAT, WITH A BELT SYSTEM

(71) Applicant: CYBEX GmbH, Bayreuth (DE)

(72) Inventors: Franz KIESLER, Bayreuth (DE); Thomas FLESSA, Bayreuth (DE); Ralf HOLLEIS, Bayreuth (DE); Gabriel ALTENHOFEN, Bayreuth (DE)

(21) Appl. No.: 18/728,759

(22) PCT Filed: Jan. 10, 2023
(86) PCT No.: PCT/EP2023/050388

§ 371 Date: Jul. 12, 2024

(30) Foreign Application Priority Data
Jan. 14, 2022 (DE) 20 2022 100 202.9

(51) Int. Cl. B62B 9/10; B62B 9/24

(52) U.S. Cl. CPC B62B 9/104; B62B 9/24

(57) ABSTRACT

Child-accommodation device, in particular pram and/or child seat, for mounting on a pram frame, wherein the child-accommodation device has a seat unit and a belt system, wherein the seat unit has a seat section and a back section which is adjustable relative to the seat section with regard to its inclination, wherein the belt system is assigned at least one compensation device which is configured in such a way that at least one extension of at least one belt section between two deflection points or a deflection point and a fastening point is at least partially compensated for by a corresponding shortening of a further belt section between two deflection points or a deflection point and a fastening point when the inclination is changed.

The invention relates to a child-accommodation device, in particular a pram and/or child seat, for mounting on a pram frame, wherein the child-accommodation device has a seat unit and a belt system.

Child-accommodation devices, such as in particular prams and/or child seats for mounting on a pram frame, are known in principle.

Prams with a seat unit consisting of a seat section and a back(rest) section are known from the prior art. It is also known that such seat units comprise a inclining function with which the backrest part can be inclined relative to the seat section in order to provide a sitting position and a lying position.

Furthermore, devices for fixing and/or safely restraining the child during transport with a pram are known. EP 2 139 746 B1 discloses a belt system with a central adjustment belt as well as a central belt fastening device for adjusting the length of the shoulder belts. By this a quick and easy adjustment of the length of the shoulder belts can be made possible. The belt system comprises a crotch belt arranged centrally on the seat section, with a buckle body located at the end, as well as two shoulder belts. The shoulder belts extend symmetrically from the lateral frame parts of the pram over the child's thighs in the direction of the buckle body, to which the shoulder belts are connected via a snap fastener and are in turn deflected symmetrically upwards over the child's shoulders. In a shoulder region of the child, the shoulder belts extend through a back section or backrest section (from the front to the back), are deflected and then run down the back of the back(rest) section. The two shoulder belts are brought together at the back to form a central adjustment belt, which is deflected so that it extends through a belt fastening device arranged centrally on the upper side of the seat section.

A guide on the back of the back(rest) section and on the underside of the seat section prevents a deformation of the seat and back(rest) section when the belt system is adjusted by the central adjustment belt. The guide also prevents the central adjustment belt from tangling or sagging.

A basically similar belt system is disclosed in US 2018/0050614 A1.

Overall, the operation and adjustment of the belt system in the solution according to the prior art is perceived as comparatively complex.

It is therefore the object of the invention to improve, and in particular to simplify, the operation and adjustment of the belt system compared to the prior art.

This object is solved in particular by the features of claim 1.

In particular, the object is solved by a child-accommodation device, in particular a pram and/or child seat for mounting on a pram frame, wherein the child-accommodation device has a seat unit and a belt system, wherein the seat unit has a seat section and a back section (backrest section) which can be adjusted relative to the seat section with regard to its inclination (or spread), wherein at least one compensation device (of the child-accommodation device), which is configured in such a way that at least one extension of at least one (variable-length) belt section is at least partially compensated for by a corresponding shortening of a further belt section when the inclination is changed, is assigned to the belt system. A belt section is defined in particular as a section of a belt of the belt system between two deflection points or a deflection point and a fastening point, whereby “between” is to be understood in particular as meaning that the belt section is limited by the aforementioned points or defined in terms of its length. Deflection and fastening points are in particular not defined by the belt itself, but by other structures (for example seat section and/or back section), so that an imaginary mark on the belt can sometimes belong to a certain section and sometimes not, depending on the adjustment (e.g. the inclination and/or relative to the size of a child).

A deflection point is preferably to be understood as a section or region of an entire belt guide at which the belt is deflected, i.e. undergoes a change in its direction of extension. In this respect, it should be noted that a “point” is not to be understood in the mathematical or geometric sense (as a zero-dimensional structure), but as a corresponding section or region. A (respective) deflection point can preferably be configured in such a way that it undergoes a deflection of an extension of the belt by at least 10° or at least 30° or at least 45° or at least 90°, possibly at least 135° or at least or exactly 180°. In general, a deflection point is characterised by the fact that the belt or belt system can slide along the deflection point (for example upon adjustment of the belt system or other changes to the child-accommodation device). According to the embodiment, a deflection point does not have a fastening function, in the sense that the belt can be fixed at the corresponding location (whereby a “fixation” in this context again is to be understood as holding a certain point of the belt at the corresponding location, as would be the case with a belt buckle or a belt lock, for example).

A fastening point is to be understood here in particular as a point that defines a section or region of the (entire) belt guide at which the belt is fixed or fastened or at least can be fixed or fastened. For this purpose, at least one corresponding fixing device (fastening device) may be present at the fastening point, such as a belt buckle or a belt lock. A fastening point can also be realised by connecting the belt to itself, in particular by sewing, riveting or the like, while enclosing an external structure (e.g. a bar). In the state of use, the corresponding fixing devices are preferably configured in such a way that the belt cannot be displaced at the corresponding fastening points (without releasing the fixing device).

In this sense, a belt system configured as a 5-point belt system preferably has at least three fastening points, namely for an end of the crotch belt as well as a respective end of two hip belts. Alternative configurations are possible.

A change in the inclination means, in particular, that the seat section and back section are spread (or folded away from each other) or rotated towards each other (or at least partially folded together). In this respect, a change in the inclination preferably corresponds to a rotation about a corresponding axis of rotation (axis of inclination) (horizontal at least in a state of use). This can, but does not have to, be formed by a corresponding (e.g. one-piece) axis (as a physical-technical structure). In this respect, for example, link guides or other structures for enabling a relative rotation are also conceivable. In particular, the seat section and back section can be connected to each other in such an axis of rotation (or via such an axis of rotation).

Preferably, no further deflection points and/or fastening points are provided between the two respective deflection points or the pair of deflection point and fastening point taken into account (which is, however, possible).

The at least partial compensation is preferably achieved solely as a result of the change in inclination (i.e. preferably assuming that the corresponding belt fixings are not released). In this sense, a release of a fixation, movement of the belt relative to the fixation and creation of a (new) fixation is in particular not to be understood as partial compensation.

The respective belt section is preferably to be considered in a case in which no child is sitting in the child seat and the belt system is fixed (and snugly or tautly tightened). Alternatively or additionally, the respective condition, in particular of claim 1, can also be fulfilled if a dummy is accommodated in the seat unit. In particular, this may be a dummy from the company Humanetics (according to the version that is or was current at the time of application or priority), for example dummies from the Q series. In particular, depending on the seat size, a suitable dummy can be selected from these dummies, for example a Q0, Q1, Q1.5, Q3, Q6 and/or Q10, whereby the number after the Q corresponds to the approximate age of a child of comparable height and weight. If a child-accommodation device is designed for more than one dummy, the respective condition may apply to at least one or several or all of the dummies.

A belt section is preferably to be understood as a (respective) continuous or one-piece (monolithic) section of the belt. However, a belt section can also be understood to mean, for example, a section of the belt system that comprises two or more one-piece (possibly monolithic) sections (e.g. textile sections) that are connected to each other by a connecting device (e.g. belt buckle and/or lock). In this sense, a belt section can also be a section of the belt system that extends from a deflection point assigned to a crotch belt via a belt buckle to a deflection point assigned to a shoulder belt.

For example, upon spreading of the child-accommodation device (or the seat section relative to the back section) a belt section can extend, which is located on a side of the seat unit facing the child and/or directly holds the child (touching it) during use and runs between a deflection point (for example an upper section of the back section) and a deflection point or fastening point on the seat section (in particular a front section of the same). This is preferably compensated for (by the compensation device) by correspondingly shortening a further belt section (for example, a belt section extending behind the child's back and/or a belt section extending under the child's buttocks and/or—in general—a belt section which does not come into contact with the child during use).

A core idea of the first aspect is, in particular, that a sectional extension of the belt system resulting from the change in the inclination of the seat unit is at least partially compensated for at another location. By this, it can be prevented, that an excessive tension of the belt system (at least in sections) occurs as a result, which usually also means increased frictional resistance when parts slide against each other and/or necessitates readjustment (new adjustment) of the belt system.

Overall, this facilitates the operation and adjustment of the child seat. In particular, it was also recognised that in known belt systems from the prior art the problem occurs that a high frictional force can arise in the deflection points of the belts, making operation and adjustment of the belt system more difficult. According to the core idea of the first aspect, such frictional forces are reduced when the belt system is adjusted, which improves the overall guidance and handling of the belt system. In a (basically known) seat unit with a inclining function, the problem arises in particular that a belt tension of the adjusted belt system varies (in some cases varies significantly) when the back section (backrest part) is moved from a sitting position (or more upright position) to a lying position (or less upright position). As a result, the belt system can be either too tight or too loose after a transfer from one position to the other, making the belt system either uncomfortable for the child or not providing sufficient protection for the child (or both). In this respect, an improvement is also achieved in particular by partially compensating for a potentially varying belt tension of the belt system when transferring the back section (backrest part) from one position to another position.

According to a second (independent) aspect (which, however, is preferably combinable with the above first aspect), the above object is solved by a child-accommodation device, in particular a pram and/or child seat, for mounting on a pram frame, wherein the child-accommodation device has a seat unit and a belt system, wherein the seat unit preferably has a seat section and a back section which can be adjusted relative to the seat section with regard to its inclination, wherein at least one belt of the belt system is deflected on at least one deflection device, wherein, when the belt system is adjusted, a contact section of the at least one belt which comes into contact with the deflection device slides (or can slide) over the deflection device at least essentially without resistance and/or with at least reduced resistance.

A core idea of the second aspect is thus to take measures that reduce frictional resistance in the region of a deflection device (or deflection point). Such a measure can, for example, comprise a surface treatment, e.g. polishing and/or lubrication, a corresponding choice of material and/or a mechanical solution, e.g. using at least one roll and/or at least of one ball bearing and/or needle bearing. This can also at least reduce the stresses explained above, as a certain amount of equalisation between individual belt sections is facilitated (in that a corresponding equalising movement of the contact section can be promoted as a result of the low friction). In particular in combination with the compensation device, an effective equalisation or reduction of undesirable tensions in the belt system can thus be achieved in a synergistic manner.

According to a third independent aspect of the invention (which preferably is combinable with the first and/or second aspect), the above object is solved in particular by a child-accommodation device, wherein the child-accommodation device has a seat unit and a belt system, wherein the seat unit preferably has a seat section and a back section which can be adjusted relative to the seat section with regard to its inclination, wherein at least one belt of the belt system is deflected on at least one deflection device, wherein the deflection device is formed at least partially by a rod, preferably of a frame or of a frame part.

According to a basic idea of the third aspect, the belt system is deflected at at least one point via a rod (preferably of a frame part). In this way, resistance forces due to the deflection can be reduced in a structurally simple manner.

According to a fourth independent aspect of the invention (which is preferably combinable with the first, second and/or third aspect of the invention), the above-mentioned is solved by a child-accommodation device, in particular a pram and/or child seat, wherein the child-accommodation device comprises a seat unit and a belt system, wherein the seat unit preferably has a seat section and a back section which is adjustable relative to the seat section with regard to its inclination, wherein at least one belt of the belt system is deflected on at least one deflection device, wherein the deflection device defines a clearance which has a contact surface (in particular a contact base surface) which comes into contact with the belt, wherein the clearance is at least partially, optionally completely, covered by a fabric cover.

A core idea of the fourth aspect is to guide the belt system or a section thereof through a clearance (preferably U-shaped in cross-section, in particular in a cross-section perpendicular to the course of the belt or its contact section), which simultaneously defines a deflection, wherein the clearance is preferably covered by a fabric cover. On the one hand, this allows the deflection to be covered in a simple manner, while on the other hand the clearance ensures that the corresponding section of the belt is not (at least not excessively) held by the fabric cover or that the same does not present any (greater) resistance during a corresponding movement through the clearance.

In particular, the clearance is U-shaped (in a side view and/or in a view along an extension of the belt section passing through the clearance). Preferably, the clearance is not a through hole and/or not a slot. In particular, the clearance is defined (without taking into account the fabric reference) by a sphere and/or not by a torus (in the topological sense).

According to a fifth aspect of the invention, which is preferably combinable with the first, second, third and/or fourth aspect, the above object is solved in particular by a child-accommodation device, in particular a pram and/or child seat, for mounting on a pram frame, wherein the child-accommodation device comprises a seat unit and a belt system, wherein the seat unit has a seat section and a back section which is preferably adjustable relative to the seat section with regard to its inclination, wherein a fastening point for a (the) crotch belt is connected in a fixed position to the back section and/or is arranged on a lower section of one (of the) back section and/or upon a spread: rotates along with the back section and/or is displaced forward relative to the seat section and/or is displaced upwards relative to the seat section.

A core idea of the fifth aspect is that the crotch belt is not mounted on the seat section (as is usually the case), but on the back section, which can preferably be spread relative to the seat section. As a result, a displacement of the back section relative to the seat section also leads to a displacement of the corresponding fastening point (relative to the seat section), which simplifies operation overall. In particular, such a measure can achieve that an effective length of the crotch belt (i.e. a length from an upper side of the seat surface to a belt buckle) is extended when the back section is spread relative to the seat section. For this purpose, the seat belt is preferably fastened to a fastening point that is below (e.g. by at least 2 cm or at least 5 cm or at least 10 cm) a level of a inclination axis (with the upper side of the seat section aligned horizontally).

In embodiments, the compensation device forms at least one first deflection point, which (relative to the course of a corresponding belt or belt system) is arranged between a second deflection point and a third deflection point (wherein preferably no further deflection point and/or no fastening point is provided between the first and second and/or between the first and third deflection point) and/or is arranged between a (the) second deflection point and a (the) fastening point (wherein preferably no further deflection point and/or no (further) fastening point is provided between the first and second deflection point and/or between the first deflection point and the fastening point), wherein the first deflection point is displaced relative to the back section and/or seat section when the back section and seat section are spread such that a belt section between the second and third deflection points and/or a belt section between the second deflection point and the fastening point is shortened, wherein preferably applies:
the first and/or second deflection point is/are designed in such a way that, when the inclination is adjusted, it/they rotates (rotate) together with the back section or rotates (rotate) together with the seat section, in particular is/are mounted in a fixed position relative to the back section or the seat section, and/or
the third deflection point and/or the fastening point is (are) designed in such a way that, when the inclination is adjusted, it (they) rotates (rotate) together with the seat section or rotates (rotate) together with the back section, in particular is (are) mounted in a fixed position relative to the back section or the seat section.

At least one deflection point, which preferably rotates together with the back section when the inclination is adjusted, can be, at least in one configuration of the child-accommodation device, below a level of an inclination axis (for example at least 2 cm or at least 5 cm or at least 10 cm and/or at most 30 cm) and/or, when the seat and back sections are spread, approach the level of the inclination axis (for example by at least 2 cm or at least 5 cm or at least 10 cm) and/or displace upwards relative to the seat section (for example by at least 2 cm or at least 5 cm) and/or displace forward (for example by at least 2 cm or at least 5 cm or at least 10 cm) and/or move away from a vertical left-right plane, in which one (the) axis of inclination lies.

A vertical left-right plane is to be understood in particular as a plane which is orientated vertically and runs from a left side to a right side of the child seat (in particular perpendicular to a front-rear plane, as a plane which can be formed by a plane of symmetry or a plane parallel thereto).

Insofar as positions of points, elements and/or sections (or other structures) are addressed in the preceding and/or following and/or a change in such positions, the respective condition or specification should preferably apply to at least one of possibly several adjustable (use) configurations (or at least one of possibly several possible configuration changes), possibly to all configurations/configuration changes that are affected accordingly. Furthermore, it should in particular be assumed that the surface (top side or seat surface) of the seat section (on which the child then sits) is at least essentially horizontal. In the case of a non-flat surface, a horizontal alignment should preferably be present if, when the surface is divided into 1 cm² squares, these squares are at least essentially horizontally aligned on arithmetic mean.

At least one deflection point (at least first deflection point), which preferably rotates together with the seat section during an inclination adjustment, can lie behind a (the) inclination axis (or a vertical left-right plane in which the axis of inclination lies) and/or be displaced forward relative to an upper end of the back section when the seat and back section are spread and/or be displaced downwards relative to a lower end of the back section (for example by at least 2 cm or at least 5 cm or at least 10 cm) and/or have a constant distance of greater than or equal to 0 cm from a (the) level of a (the) axis of inclination.

A fastening point for a (the) crotch belt is preferably connected in a fixed position to the back section and/or arranged at a lower section of the back section. Furthermore, the fastening point can (alternatively or additionally) when spread: rotate with the back section and/or move forward relative to the seat section (e.g. by at least 2 cm or at least 5 cm or at least 10 cm) and/or move upwards relative to the seat section (for example by at least 2 cm or at least 5 cm or at least 10 cm).

Furthermore, a fastening point for one or more shoulder belts can be connected in a fixed position to the seat section and/or can be arranged at a front section of the seat section and/or when spread: can rotate with the seat section and/or can displace forward relative to the back section and/or can approach the back section.

The following preferably applies here (above and below): A front section of a referenced structure is understood to be a section comprising a front end of the referenced structure and extending over (up to) 50% of the length thereof, in particular over only 30% of the length. A rear section of a referenced structure is understood to be a section comprising a rear end of the referenced structure and extending over (up to) 50% of the length thereof, in particular over only 30% of the length. A lower section of a referenced structure means a section comprising a lower end of the referenced structure and extending over (up to) 50% of the length thereof, in particular over only 30% of the length. An upper section of a referenced structure means a section comprising an upper end of the referenced structure and extending over (up to) 50% of the length thereof, in particular over only 30% of the length.

The seat section preferably has a seat surface (to accommodate the child's thighs and buttocks) and possibly side bolsters for lateral support or lateral protection of the child. The back section preferably has a backrest (for leaning the child's back against) and possibly side sections or side bolsters for lateral support and/or lateral protection of the child in the back region.

In one embodiment, a fastening point for a (the) crotch belt and a deflection point for at least one shoulder belt (or a connecting belt that connects to two shoulder belts in a Y-shape) can coincide (at least essentially) at least in a projection onto a vertical front-rear plane.

This is a simple and clear way of compensating for changes in a length of a particular section of the belt. It is particularly preferable for the fastening point or deflection point to be arranged below the inclination axis (by at least 2 cm or at least 5 cm or at least 10 cm).

A coefficient of static friction between a material of the contact section and a material of the deflection device (which comes into contact with the contact section) is preferably less than or equal to 0.5, further preferably less than or equal to 0.25, still further preferably less than or equal to 0.1, and/or greater than or equal to 0.01. Alternatively or additionally, a coefficient of sliding friction between a (the) material of the contact section and a (the) material of the deflection device (which comes into contact with the contact section) is preferably less than or equal to 0.4, further preferably less than or equal to 0.20, still further preferably less than or equal to 0.08, and/or greater than or equal to 0.005.

The coefficient of friction can preferably be determined in accordance with DIN-EN-ISO 8295 (valid on the application or priority date). Particularly in the case of a non-isotropic coefficient of friction, it is preferable to assume a constellation that also corresponds to the movement (or sliding) of the contact section along (or in) the deflection device.

A surface of the deflection device preferably comprises or consists of a thermoplastic, more preferably ABS, PA, PE and/or PP.

The deflection device may, according to an embodiment, comprise at least one deflection roll and/or at least one ball bearing and/or at least one needle bearing.

In the region of the deflection (or the corresponding deflection point), the belt preferably does not come into contact with a cover (fabric cover).

In embodiments, the belt system can be configured as a 5-point belt or a 3-point belt. Alternatively or additionally, the belt system is a one-pull harness (i.e. a belt system with centralised, in particular pulling, adjustment or adjusting).

Particularly preferably, the child-accommodation device is configured as a pram (or as a child-carrying unit for a corresponding pram, for example for mounting on a pram frame), in particular as a child carrier and/or buggy and/or bicycle trailer.

The pram (e.g. child carrier or buggy) can comprise a frame and a seat unit comprising the seat section and the back section (or backrest section). The back section (backrest section) is preferably adjustable by means of a inclining function at least between an (at least essentially) upright sitting position and a lying position that is flattened compared to the sitting position Furthermore, a belt system is preferably provided for fixation of a child located on the seat section.

According to a general idea, the belt system can be configured in such a way that it at least partially compensates for a varying belt tension (and/or at least sectional belt length change) when using the inclination function.

Alternatively to this general idea (or in addition thereto), the child-accommodation device (pram) has at least one deflection device (deflection element) which enables an improved (optimum) guidance of the belt system and reduces any friction arising during adjustment of the belt system.

A frame of the pram may have at least one front leg, at least one rear leg and at least one pusher (and possibly at least one cross brace). Generally, the frame may comprise several bars and/or other elongate elements. Preferably, the frame comprises at least one front leg and two rear legs, further preferably two front legs and two rear legs, wherein at least one cross brace may be provided between the two front and/or two rear legs for stabilisation.

The at least one front leg can be connected to the at least one rear leg and/or the at least one pusher in at least one joint, for example in order to be able to bring the frame into a use position or a transport position.

The frame of the pram may have at least three wheels, preferably one wheel per leg, but possibly two wheels per leg are also possible.

The child-accommodation device (e.g. pram) comprises a seat unit comprising a seat section and a back section (backrest section). Preferably, the child-accommodation device (e.g. pram) further comprises a frame, wherein the seat unit can either be integrally formed on the frame, or additionally or preferably alternatively the frame can have at least one fastening option for the seat unit. The seat section is preferably configured in such a way that it accommodates or supports the buttocks and/or the legs and/or the thighs of a child, at least in sections. The back(rest) section is preferably configured in such a way that it accommodates or supports the child's back and/or head. The seat unit can be an integral part of the child-accommodation device (e.g. pram) through a fixed connection to the pram frame or can be detachably arranged on the frame (pram frame) through corresponding fastening options.

If the seat unit is designed as an integral part of the child-accommodation device (e.g. pram), it can essentially consist of textiles attached to the frame of the pram. In addition, plates and/or plate-like elements (e.g. PE plates) can be supported by the textiles for stabilisation, in particular inserted and/or sewn into them. Furthermore, the seat unit can comprise additional cross and/or side braces as well as at least one joint, which can be firmly connected to the frame. The at least one joint may be identical to or preferably different from the at least one joint which connects the at least one front leg and/or the at least one rear leg and/or the at least one pusher to one another.

If the seat unit is detachably arranged on the child-accommodation device (e.g. pram), the frame comprises at least one attachment option for the seat unit, such as an adapter. Similar to the seat unit formed integrally with the child-accommodation device (e.g. pram), the removable seat unit can comprise cross and/or side braces, plates and/or plate-like elements as well as shell-shaped elements (e.g. seat shell) which are supported by the textiles, in particular are inserted and/or sewn into them.

Preferably, the seat unit is designed such that the seat section comprises a plate-like and/or shell-like element, in particular a seat shell, and the back(rest) section comprises a frame, in particular an at least partially circumferential frame of side and cross braces. In addition or preferably alternatively, the back(rest) section may also be formed comprising a plate and/or a plate-like element. In addition, the seat section and the back(rest) section may comprise (in particular removable) textile elements, wherein at least one textile element may be provided on at least one upper and/or underside of the seat section and/or at least one textile layer may be provided on at least one front and/or rear side of the back(rest) section.

The seat unit preferably comprises a inclining function, whereby an angle of the back(rest) section relative to the seat section can be adjusted, preferably such that the back(rest) section can be brought at least into an essentially upright sitting position and into a lying position which is flattened, possibly a horizontal and/or approximately horizontal position, relative to the sitting position wherein further positions between the sitting position and the lying position can also be provided.

The back(rest) section defines in particular a backrest of the seat unit, and the seat section defines a seat surface of the seat unit. Backrest and seat section limit, at least in sections, an accommodation space for a child.

The back(rest) section can preferably be coupled in a lower region to the seat section (preferably to a rear region thereof) via the at least one joint of the seat unit in such a way that the back(rest) section, during the inclining adjustment, moves from an upright sitting position to a flattened, possibly horizontal and/or approximately horizontal, lying position partially under and/or over the seat section or so that the seat section, during the inclining adjustment, moves from an upright sitting position to a flattened, possibly horizontal and/or approximately horizontal, lying position partially under and/or over the back(rest) section.

In one embodiment, the at least one joint, in particular two joints between the seat section and the back(rest) section, preferably a right joint and a left joint, can define an axis. In particular, this may be an imaginary axis that is physically defined (only) by the at least one joint, in particular by the two joints. In this embodiment, the axis can run through the accommodation space. As a result, it can be achieved that the seat section and the back(rest) section have a smaller distance from each other and/or a greater overlap in the lying position than in the sitting position.

Specifically, the seat surface and backrest (except for the joint) can be spaced apart from each other in the sitting position and directly adjacent to each other in the lying position. However, the seat surface and backrest can also be directly adjacent to each other in the sitting position and overlap in the lying position. Mixed forms or slight variations of these embodiments are also conceivable.

The back(rest) section may have a first guide section which is intended to guide at least one belt of the belt system in at least one position of the seat unit and which is designed such that, in the at least one position, it projects downwards beyond the seat section and/or projects beyond the part of the back(rest) section defining the backrest in a direction pointing away from the backrest.

Alternatively or in addition to the first guide section of the back(rest) section, the seat section may have a second guide section which is provided to guide at least one belt of the belt system in at least one position of the seat unit and which is designed such that, in the at least one position, it projects downwards beyond the part of the seat section defining the seat surface and/or projects beyond the part of the back(rest) section defining the backrest in a direction pointing away from the backrest and/or away from the accommodation space.

In one embodiment, the back(rest) section may have a first guide section which, in the sitting position of the seat unit, projects downwards beyond the section of the seat section defining the seat surface, and which, when the seat unit is transferred to the lying position, approaches an underside of the seat section and, if necessary, can abut against it.

In one embodiment, the seat section may have a second guide section which, when the seat unit is in the sitting position, projects rearwardly beyond the part of the back(rest) section defining the backrest, and which, when the seat unit is transferred to the lying position, approaches a rear side of the back(rest) section and, if necessary, can abut against it.

In one embodiment, the back(rest) section may have a first guide section which, when the seat unit is in the sitting position, projects rearwardly beyond the part of the back(rest) section defining the backrest, and the seat section may have a second guide section which projects downwardly beyond the section of the seat section defining the seat surface. When the seat unit is transferred to the lying position, the first guide section can approach the second guide section.

The crotch belt of the belt system can be attached to the seat section and/or deflected from the top to the bottom of the seat section via a further opening arranged on the seat section and be attached in a lower region (possibly at a lower end) of the back(rest) section.

Alternatively or in addition to the embodiments shown above, the crotch belt can be attached to a lower end of a layer (possibly a textile layer) or also to a lower cross brace of the back(rest) section. Furthermore, according to an embodiment, the crotch belt can be detachably arranged in a lower section (possibly at the lower end) of the back(rest) section by means of a suitable fastening mechanism (e.g. a buckle) in order to enable easy removal of the layers of the back(rest) section (possibly the textile layers).

By the attachment of one end of the crotch belt to a lower section (possibly to a lower end) of the back(rest) section, the varying belt tension of the belt system can be compensated for when adjusting the inclination of the back(rest) section.

By changing the inclination of the back(rest) section, for example from an upright sitting position to a lying position, the lower end of the back(rest) section can move at least partially under or over the seat section and thus come closer to the opening at the seat section through which the crotch belt is guided, or can, by changing the position of at least one of the guide sections shown above, shorten the distance to be bridged by the crotch belt between its attachment and the opening in the seat section provided for the crotch belt to pass through can be shortened. If the crotch belt is attached to a lower section (possibly to a lower end) of the back(rest) section, the free length of the crotch belt (measured from the surface of the seat section to the belt buckle arranged at one end of the crotch belt) changes from a length L1 to a different, preferably greater, length L2 in a closed state of the belt system. By this, the length of the belt system required to maintain the same belt tension in a sitting and/or lying position can be compensated for by the change in length of the crotch belt from length L1 to length L2. If the inclination of the back(rest) section is changed in the opposite direction, the reverse effect occurs.

Mixed forms, variations and/or combinations of the different embodiments are also possible.

At least one deflection device (deflection element) can be provided on the seat section and/or the back(rest) section (preferably at least on the back(rest) section), wherein the deflection device (deflection element) is configured in such a way that optimum guidance of the belt system is possible with minimum friction when adjusting the belt system.

The at least one deflection device (deflection element) can be arranged in an upper and/or lower section (possibly upper and/or lower end) of the back(rest) section, in particular on an upper and/or lower cross brace of the frame of the back(rest) section, and/or on a rear section (possibly rear end) of the seat section facing the backrest section and/or on a underside of the seat section. In principle, a deflection device (deflection element) can be provided for each deflection point at which a belt of the belt system is deflected, but preferably in particular one deflection device (deflection element) per shoulder belt is provided in an upper section (possibly at an upper end) of the back(rest) section, in particular on an upper cross brace of the frame of the backrest section.

According to an embodiment, the deflection device (deflection element) can preferably have at least essentially a U-shape or H-shape in a frontal view and/or in a cross-section, although other shapes with a recess (clearance) (possibly located between two elevations) are also conceivable. Alternatively or additionally, the recess (clearance) forms a hollow cylinder, in particular a circular ring hollow cylinder (if one considers the space that defines the recess or imagines this space filled with material). Alternatively or additionally, the recess (clearance) may be defined by a pair of ring structures rising on a cylindrical base structure.

A belt of the belt system, in particular the shoulder belt, preferably runs in the recess of the deflection device (deflection element), whereby preferably lateral elevations or side walls of the recess or clearance serve to guide the belt laterally and prevent the belt from slipping out of the deflection device (deflection element) laterally when the belt system is adjusted.

In another embodiment, the deflection device (deflection element) can preferably have a recess clearance in an elongated form (e.g. a slot), although other forms of recess clearance that enable belt guidance are also conceivable.

The deflection device (deflection element) can preferably be attached (in particular fastened) as a separate component or as a component group in an upper section (possibly at an upper end) of the back(rest) section and/or be designed as an integral part of an upper section (possibly upper end) of the back(rest) section. An upper section (possibly an upper end) of the back(rest) section itself can also be moulded in such a way that a recess and/or two elevations and/or a recess clearance are present, in which the belt of the belt system can be guided and deflected. An upper section of the back(rest) section comprises in particular the upper end of the back(rest) section. An upper end of the back(rest) section can be understood to mean, for example, an upper cross brace of the frame of the back(rest) section, or the upper edge of a plate and/or a plate-shaped element of the back(rest) section.

According to an embodiment, the deflection device (deflection element) can be formed integrally with a cross brace of the frame such that the cross brace forms a taper for guiding a belt.

In another embodiment, the deflection device (deflection element) can be formed integrally with a cross brace of the frame in such a way that the cross brace forms two thickenings between which a belt can be guided.

In another embodiment, the deflection device (deflection element) can be formed separately from a cross brace of the frame and attached to it in such a way that two thickenings and/or a taper (possibly located between the two thickenings) can be formed.

In another embodiment, the deflection device (deflection element) can be formed integrally with a cross brace of the frame such that the cross brace has a recess clearance through which a belt can be guided.

In another embodiment, the deflection device (deflection element) can be formed separately from a cross brace of the frame and attached to it in such a way that a recess clearance can be formed.

According to an embodiment, the deflection device (deflection element) can be formed integrally with a plate and/or a plate-shaped element of the back(rest) section, such that the plate and/or the plate-shaped element forms a recess for guiding a belt.

In another embodiment, the deflection device (deflection element) can be formed integrally with a plate and/or a plate-shaped element of the back(rest) section, such that the plate and/or the plate-shaped element forms two elevations between which a belt can be guided.

In another embodiment, the deflection device (deflection element) can be formed separately from a plate and/or a plate-shaped element of the back(rest) section and can be attached to the back(rest) section in such a way that two elevations and/or a recess (possibly located between the elevations) are formed.

In another embodiment, the deflection device (deflection element) can be formed integrally with a plate and/or with a plate-shaped element of the back(rest) section such that the plate and/or the plate-shaped element has/have a recess clearance through which a belt can be guided.

In another embodiment, the deflection device (deflection element) can be formed separately from a plate and/or a plate-shaped element of the back(rest) section and can be attached to the back(rest) section in such a way that a recess clearance can be formed.

In order to minimise the frictional force generated in the at least one deflection point of the belt system by the at least one deflection device (deflection element), according to an embodiment the deflection device (deflection element) can be made of a low-friction material (e.g. a thermoplastic, such as ABS, PA, PE or PP) or in any case have a surface made of such a material.

In another embodiment, the deflection device (deflection element) can also comprise a roll and/or a roll-like element (e.g. a deflection roll).

Alternatively or additionally, the frictional force generated in the at least one deflection point of the belt system can be minimised by the at least one deflection device (deflection element) by preventing direct (immediate) contact between the belt and at least one layer of the back(rest) section (such as a textile layer) in the at least one deflection point.

Combinations of the aforementioned embodiments are also conceivable and in accordance with the invention.

The belt system can comprise at least one lap belt and at least one shoulder belt, preferably two lap belts and two shoulder belts, whereby preferably one lap belt and one shoulder belt can each form sections of a combined shoulder/lap belt, alternatively the belts can also be formed separately. In addition, the belt system preferably comprises a crotch belt, one end of which can be attached to the seat section or can be deflected on the latter, as well as possibly a belt buckle, which is attached to another end of the crotch belt, a central adjustment belt, and a central belt fastening device to lock the central adjustment belt.

The at least one lap belt can extend laterally at the child's hip height from the seat unit towards the belt buckle. The at least one shoulder belt preferably extends (transversely) over the chest or one half of the chest and possibly the stomach of the child (from the shoulder in the direction of the belt buckle). A connecting element, in particular a belt tongue, can be provided on a respective lap belt and/or on a respective shoulder belt to connect the respective belt to the belt buckle (possibly slide-movably). In the case of combined shoulder/lap belts with a lap belt section and shoulder belt section, one connecting element, in particular a belt tongue, can be provided for each combined shoulder/lap belt. The respective combined shoulder-lap belt can then be deflected by a guide on the belt buckle or on the belt tongue so that the section of the guide on which the deflection takes place forms an angle aα between 30° and 60°, preferably at least approximately 45°, possibly exactly 45°, to the horizontal and/or vertical.

In a shoulder region of the child, the at least one shoulder belt is preferably guided into and/or through the back(rest) section, preferably into the back(rest) section, further preferably at least behind a front layer of the back(rest) section, for example a textile layer (or a fabric cover). According to the embodiment, the at least one shoulder belt is deflected by the at least one deflection device (deflection element) in the upper section (possibly at the upper end) of the back(rest) section in such a way that the shoulder belt runs down at least behind the first layer of the back(rest) section in the direction of the seat section.

Preferably behind at least the front layer of the back(rest) section, the at least one shoulder belt, more preferably two shoulder belts, is brought together to form a central adjustment belt. The bringing together can be realised, for example, either via a connecting piece, to which the at least one shoulder belt and the central adjustment belt can each be attached, or by sewing the belts together. According to an embodiment, a bringing together in and/or under the seat section is also conceivable.

The at least one shoulder belt and/or the central adjustment belt can run behind at least the front layer of the back(rest) section at least partially within the back(rest) section, preferably in front of a rear layer (for example a further textile layer), further preferably between two layers of the back(rest) section (for example between two textile layers), in particular in order to prevent soiling and/or twisting and/or tangling of the belts.

In general, low-friction textile layers (for a fabric cover) can be used, although other materials or other types of fabrics (e.g. plastic layers) are also conceivable.

In particular, the at least one deflection device (deflection element) can also be located between two layers of the back(rest) section, preferably between the layers between which the at least one shoulder belt and/or the central adjustment belt also run, so that the belt to be deflected can be guided directly (immediately) over the deflection device (deflection element).

If necessary, (at least) one of the layers of the back(rest) section can also have (at least) one recess clearance in the region of the at least one deflection device (deflection element) in such a way that the belt to be deflected can be guided directly (immediately) over the deflection device (deflection element).

The central adjustment belt can be deflected again in a lower section (possibly at a lower end) of the back(rest) section and/or in a transition region between the backrest section and the seat section and/or in a rear region of the seat section (possibly below the seat section) and be guided in the direction of a front end of the seat section, wherein the central adjustment belt can be guided (from the seat section and/or from an underside of the seat section) to an upper side of the seat section through a belt fastening device (or a corresponding fastening point) preferably arranged centrally in a front region of the seat section.

A respective belt fastening device (or a corresponding fastening point) can in particular be designed such that it always permits movement of the belt guided therethrough in a first direction (at least if a corresponding force acting on the belt exceeds a predetermined value, for example 20N, or 10N, or 5N), and that it permits movement of the belt in a second direction opposite to the first direction only if a release section of the belt fastening device is actuated at the same time. The first direction is preferably a direction from the underside of the seat section to the upper side of the seat section, such that a free end of the adjustment belt is extended and the shoulder belts are pulled further at least behind the first layer of the back(rest) section.

The central adjustment belt can therefore preferably have an actuating section at the free end, whereby the free length of the shoulder belts or the belt tension of the belt system is adjusted by pulling on the actuating section and locked by the central belt fastening device. The central belt fastening device can comprise a release section (possibly comprising a lever and/or a button and/or a slider), the actuation of which can release a lock of the central adjustment belt.

The crotch belt of the belt system may be attached to the seat section and/or may be redirected from the upper side to the underside of the seat section or into the seat section through an opening (which may be identical to or different from the opening provided for the passage of the central adjustment belt) arranged on the seat section and attached in a lower section (possibly at a lower end) of the back(rest) section. According to an embodiment, the deflection of the crotch belt and/or further deflections of other belts of the belt system can also take place by means of deflection devices (deflection elements) of the type illustrated above.

When reference is made in the foregoing to a child and to various regions defined by the child (such as a hip height or a shoulder region and the like), this should be understood to mean the corresponding regions defined by dummies usually used in child seat development. In particular, these may be dummies from the company Humanetics, for example dummies from the Q series. Depending on the seat size, the person skilled in the art will select the appropriate dummy or dummies from these dummies, for example a Q0, Q1, Q1.5, Q3, Q6 and/or Q10, whereby the number after the Q corresponds to the approximate age of a child of comparable height and weight. The (respective, above and/or below described) child-accommodation device may be configured to be mounted on a motor vehicle seat, in particular configured as a child seat for mounting on a motor vehicle seat.

Furthermore, the above object is independently solved by a method for folding and/or unfolding the seat and back section of a seat unit of the child-accommodation device described above and below, wherein functionally formulated features can be replaced by corresponding method steps.

Furthermore, the above-mentioned object is solved independently by a method for manufacturing the child-accommodation device described above and below, wherein a surface of the deflection device is preferably smoothed, for example by polishing.

Further embodiments arise from the dependent claims.

In the following, the invention is explained with reference to the illustrations with regard to the further features and advantages. Hereby show:

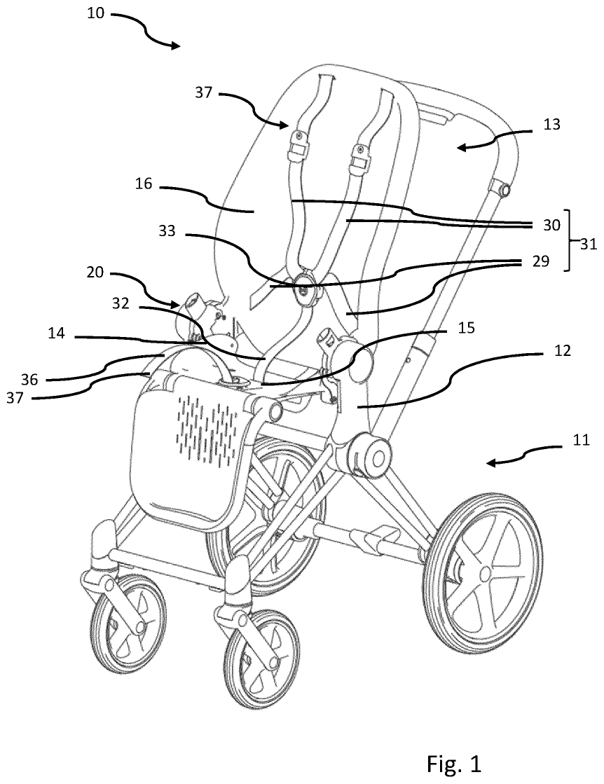

FIG. 1 an oblique view of a pram according to the invention;

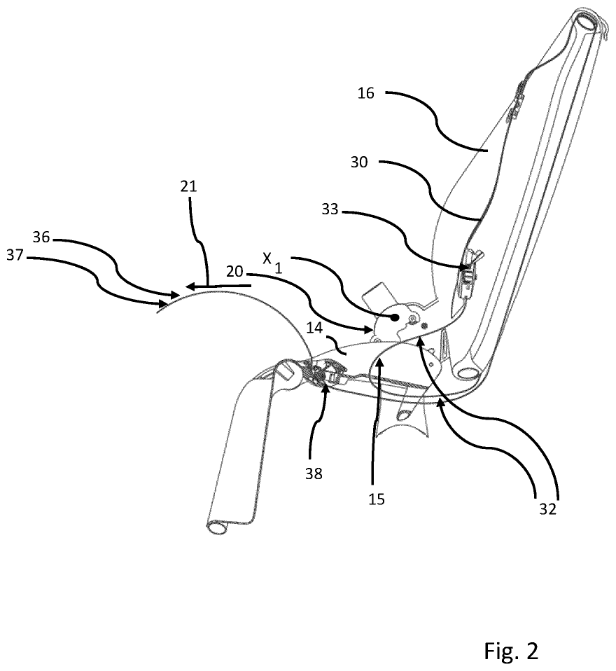

FIG. 2 a cross-section of the seat unit including belt system in the sitting position;

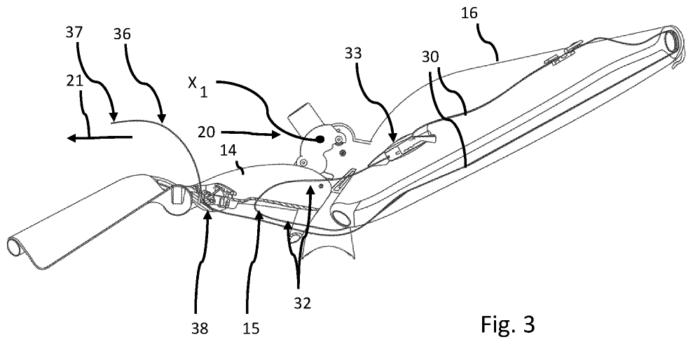

FIG. 3 a cross-section of the seat unit including belt system in the lying position;

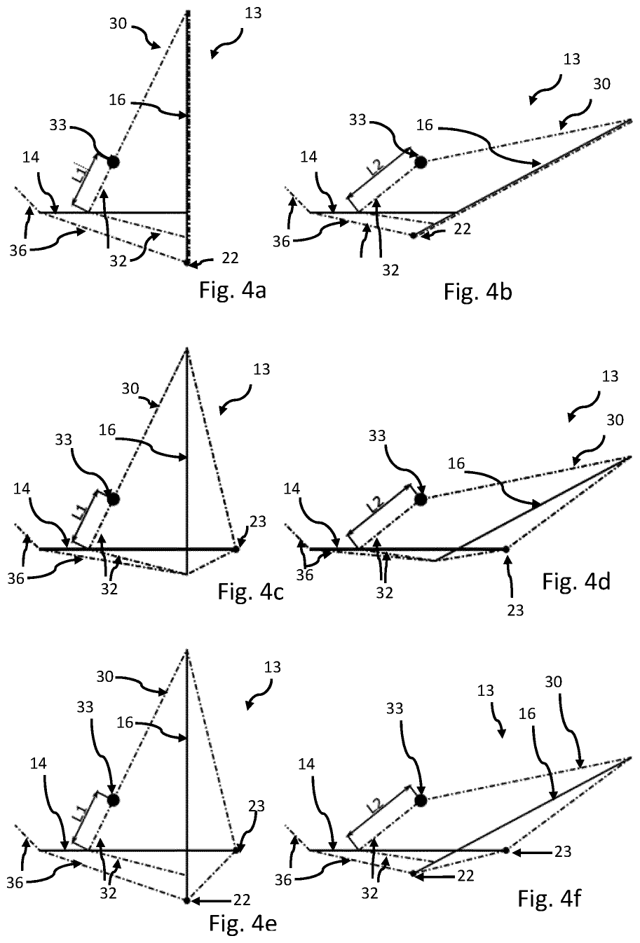

FIGS. 4a-4f schematically further embodiments of the first group of embodiments of the invention;

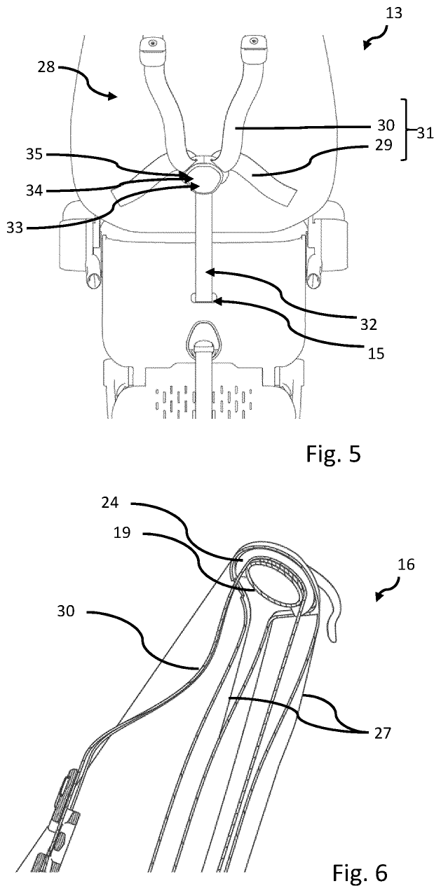

FIG. 5 a frontal view of the seat unit including belt system;

FIG. 6 a cross-section of the upper section of the back(rest) section;

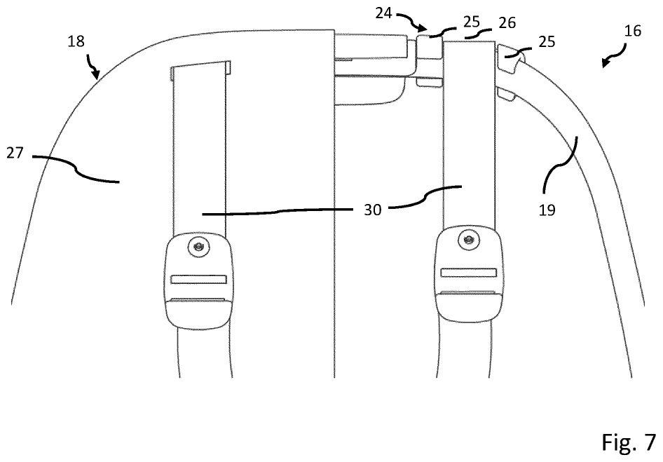

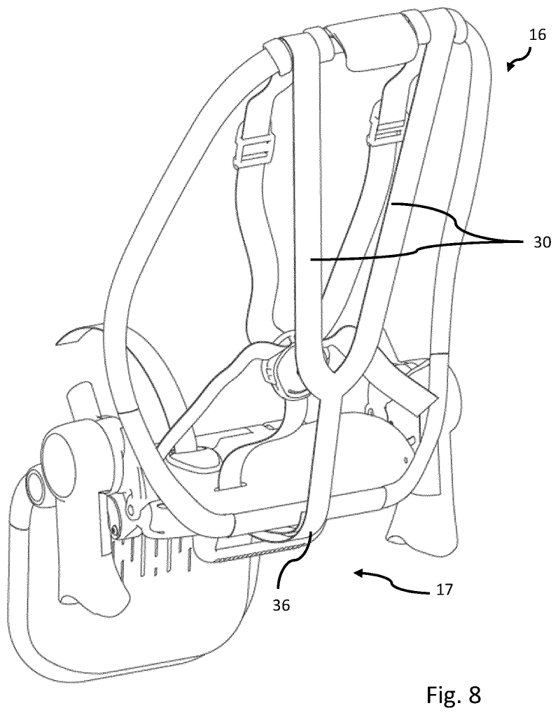

FIG. 7 a frontal view of the upper section of the back(rest) section;

FIG. 8 an oblique view of the rear side of the seat unit including belt system;

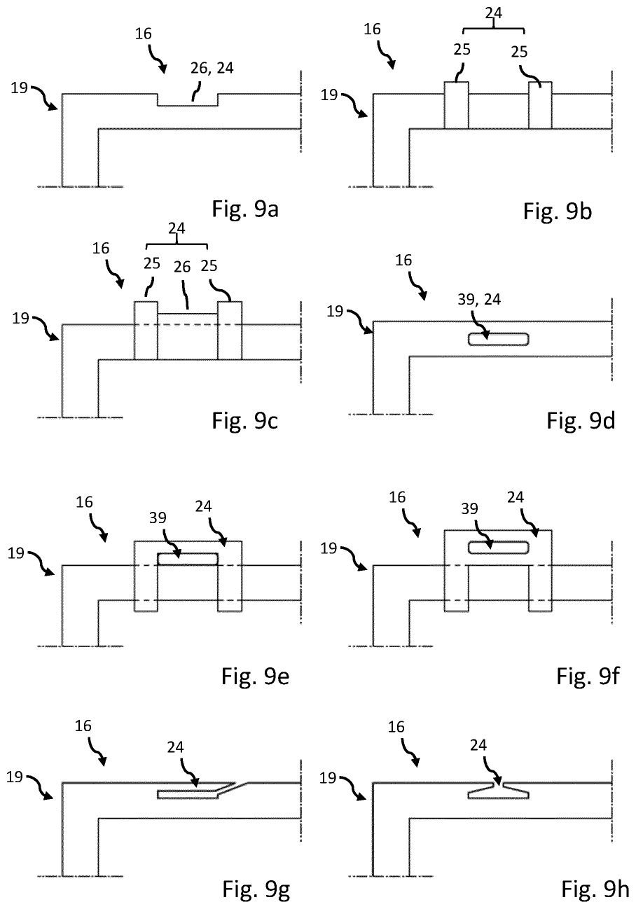

FIGS. 9a-9h schematically further embodiments of the second group of embodiments of the invention;

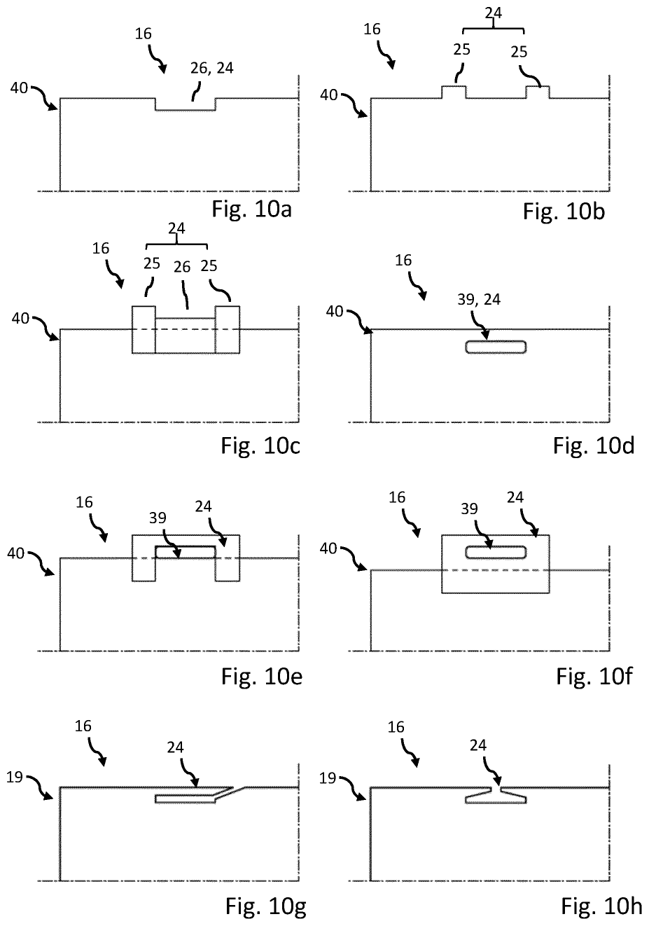

FIGS. 10a-10h schematically further embodiments of the second group of embodiments of the invention.

In the following description, the same reference numerals are used for identical and identically acting parts.

FIG. 1 shows an exemplary illustration of a pram 10 according to the present invention. The pram 10 comprises a frame 11 as well as a seat unit 13. The seat unit 13 is detachably connected to the frame 11 via fastening options 12 (e.g. adapters).

The seat unit 13 has a seat section 14 and a back section (backrest section) 16, wherein the seat section 14 defines a seat surface of the seat unit 13 and the back section 16 defines a backrest of the seat unit 13 and the seat surface and backrest delimit, at least in sections, an accommodation space 21 for a child. Furthermore, the seat unit 13 (see FIGS. 2 and 3) comprises an inclination function. The back section 16 is movably coupled to the seat section 14 via joints 20 and can thus be moved from an upright sitting position (FIG. 2) to a flattened, possibly horizontal and/or almost horizontal, lying position (FIG. 3).

The seat unit 13 additionally comprises several (in particular removable) textile elements 27, which are described in more detail below.

Furthermore, FIG. 1 shows a belt system 28 in connection with the seat unit 13, wherein the belt system 28 comprises two lap belts 29 and two shoulder belts 30, which are formed as sections of a combined shoulder-lap belt 31, a crotch belt 32, which is guided and deflected through an opening 15 on the seat section 14, as well as a belt buckle 33, which is attached to the end of the crotch belt 32 and that projects into the receiving space 21 of the seat unit 13. Furthermore, the belt system 28 comprises a central adjustment belt 36 with an actuating section 37 as well as a central belt fastening device 38 for locking the central adjustment belt 36.

FIGS. 2 and 3 illustrate the mode of operation of a first embodiment of the invention in which the belt system 28 is configured to at least partially compensate for belt tension that varies when the inclination function is used.

As can be seen in FIGS. 2 and 3, the seat unit 13 comprises a inclination function, wherein the back section 16 in FIG. 2 is in an (at least essentially) upright sitting position and in FIG. 3 is in a flattened, possibly in a horizontal and/or approximately horizontal, lying position relative to the sitting position. The back section 16 is coupled in a lower region to the seat section 14 (in a rear region thereof) via the joints 20 of the seat unit 13, wherein the joints 20 (as can be seen in FIG. 1) define an imaginary axis X1 which is physically defined (only) by the joints 20 and extends through the accommodation space 21. Alternatives for enabling a relative rotation of the seat and back section are possible.

During the inclination adjustment of the back section 16 from an upright sitting position to the flattened lying position, the back section 16 moves at least partially under the seat section 14, whereby it is achieved that the seat section 14 and the back section 16 have a smaller distance from each other and/or a larger overlap in the lying position than in the sitting position.

The crotch belt 32 of the belt system 28 is deflected through an opening 15 arranged on the seat section 14 from its upper side to its underside and is attached to a lower section 17 (possibly to a lower end) of the back section 16. By attaching one end of the crotch belt 32 to a lower section 17 (possibly to a lower end) of the back section 16, the distance to be bridged between the attachment of the crotch belt 32 and the opening 15 in the seat section 14 provided for the crotch belt 32 to pass through is shortened during the change in inclination from an upright sitting position to a lying position. As a result, in a closed state of the belt system 28, the free length L of the crotch belt 32 (measured from the surface of the seat section 14 to the belt buckle 33 arranged at one end of the crotch belt 32) changes from a length L1, in the sitting position of the back section shown in FIG. 2 to a different, preferably greater, length L2 in the lying position of the backrest section 16 shown in FIG. 3. In this way, the length L of the belt system 28 required to maintain the same belt tension in a sitting and/or lying position can be compensated for by the change in length of the crotch belt 32 from length L1 to length L2. If the inclination of the backrest section 16 is changed in reverse (from FIG. 3 to FIG. 2), the opposite effect occurs.

FIGS. 4a-4f schematically illustrate further embodiments of the invention, which may be provided independently of or in combination with the previously described embodiment.

FIGS. 4a and 4b show the back section 16 with a guide section (deflection point) 22, which projects downwards beyond the seat section 14 when the seat unit 13 is in the sitting position. When the seat unit 13 is transferred to a lying position, the guide section (deflection point) 22 approaches the underside of the seat section 14 and may abut against it.

FIGS. 4c-4d show the seat section 14 with a guide section (deflection point) 23, which projects rearwards beyond the backrest section 16 when the seat unit 13 is in the sitting position. When the seat unit 13 is transferred to a lying position, the guide section (deflection point) 23 approaches the rear of the back section 16 and may abut against it.

FIGS. 4e-4f show the back section 16 with a guide section (deflection point) 22, which projects downwards beyond the seat section 14 when the seat unit 13 is in the sitting position. In addition, the seat section 14 has a further guide section (deflection point) 23, which projects rearwards beyond the back section 16 when the seat unit 13 is in the sitting position. When the seat unit 13 is transferred to the lying position, the guide section (deflection point) 22 approaches the further guide section (deflection point) 23.

The guide section (deflection point) 22 and/or the (further) guide section (deflection point) 23 in FIGS. 4a-4f create a diversion for the central adjustment belt 36 and/or for the shoulder belts 30 when the seat unit 13 is in the sitting position. When the seat unit 13 is transferred to a lying position, this diversions is reduced by the approach of the guide section (deflection point) 22 to the underside of the seat section 14 or the approach of the (further) guide section (deflection point) 23 to the rear of the backrest section 16 or the approach of the guide section (deflection point) 22 to the (further) guide section (deflection point) 23. As a result, the central adjustment belt 36 and/or the shoulder belts 30 have more free length available to partially compensate for the varying belt tension during the inclination adjustment.

Combinations of the aforementioned embodiments are also conceivable and in accordance with the invention.

Further aspects are explained below, which in particular enable improved guidance of the belt system 28 and reduce the resulting friction when adjusting the belt system 28.

FIG. 5 shows a frontal view of the seat unit 13 and reveals a belt system 28 according to the invention. The belt system 28 comprises two lap belts 29 and two shoulder belts 30, wherein one lap belt 29 and one shoulder belt 30 are each formed as sections of a combined shoulder-lap belt 31. In addition, the belt system 28 comprises a crotch belt 32, which is deflected at the seat section 14 as shown in FIGS. 2 and 3, as well as a belt buckle 33, which is attached to the end of the crotch belt 32 projecting into the accommodation space 21 of the seat unit 13.

The lap belts 29 extend laterally at the child's hip height from the seat unit 13 in the direction of the belt buckle 33. The shoulder belts 30 extend across the child's chest and stomach also in the direction of the belt buckle 33. The combined shoulder/lap belts 31 with lap belt section 29 and shoulder belt section 30 comprise a connecting element 34, in particular a belt tongue, for each combined shoulder/lap belt 31 for connecting the respective combined shoulder/lap belt 31 to the belt buckle 33. By means of a guide 35 on the connecting element 34, in particular a belt tongue, the respective combined shoulder-lap belt 31 can be deflected in such a way that the section of the guide 35 at which the deflection takes place forms an angle α between 30° and 60°, preferably approximately 45°, possibly exactly 45°, to the horizontal and/or vertical.

In a shoulder region of the child, the shoulder belts 30 are guided into (in) the backrest section 16 or behind a textile element 27. FIG. 6 shows the guidance of the shoulder belt 30 within the back section 16, wherein the shoulder belt 30 is guided on the front side of the back section 16 behind a textile element 27 in the direction of the upper section 18, in particular the upper cross brace 19 of the frame of the backrest section 16. There, the shoulder belt 30 is deflected by the deflection device (deflection element) 24 (which is described in more detail below) to the rear side of the backrest section 16 and in the direction of the seat section 14, where the shoulder belt 30 henceforth runs between two textile elements 27.

FIG. 7 shows a frontal view of the back section 16 and reveals the deflection device (deflection element) 24, which is attached (in particular fastened) in an upper section 18, in particular to the upper cross brace 19 of the frame of the back section 16, preferably as a separate component. The deflection device (deflecting element) 24 has a U-shape in the frontal view, wherein the deflection device (deflecting element) 24 comprises two elevations 25 and a recess 26 located between the two elevations 25. The shoulder belt 30 runs in the recess 26 of the deflection device (deflection element) 24, wherein the lateral elevations 25 serve to guide the belt laterally and prevent the shoulder belt 30 from slipping laterally out of the deflection device (deflection element) 24 when the belt system 28 is adjusted.

The deflection device (deflection element) 24 is made of a low-friction material (e.g. a thermoplastic, such as ABS, PA, PE or PP) in order to minimise the frictional force generated in the deflection point of the shoulder belt 30. In addition, in this embodiment, as can be seen in FIG. 6, the lateral elevations 25 of the deflection device (deflection element) 24 prevent a direct (immediate) contact between the shoulder belt 30 and the textile element 27 of the back section 16 at this deflection point, which further minimises the resulting frictional force.

As can be seen in FIG. 8, the two shoulder belts 30 are brought together on the rear side of the back section 16 with the central adjustment belt 36 by sewing the belts together. Like the shoulder belts 30, the central adjustment belt 36 runs on the rear side of the back section 16 within two textile elements 27 in the direction of the seat section 14, wherein the central adjustment belt 36 is deflected again in a lower section 17 of the back section 16 and guided in the direction of a front end of the seat section 14.

FIG. 2 shows the guidance of the central adjustment belt 36 from the underside of the seat section 14 through the centrally arranged belt fastening device 38 to the upper side of the seat section 14. The free end of the central adjustment belt 36 has an actuating section 37, whereby the free length of the shoulder belts 30 or the belt tension of the belt system 28 can be adjusted by pulling on the actuating section 37 in the direction of arrow Z1. As a result, the free end of the central adjustment belt 36 extends and pulls the shoulder belts 30 further behind the textile element 27 arranged on the front side of the back section 16.

The belt fastening device 38 is configured to allow a movement of the central adjustment belt 36 in the direction of arrow Z1 (at least when a corresponding force acting on the central adjustment belt 36 exceeds a predetermined value) and to prevent a movement of the central adjustment belt 36 in the opposite direction to arrow Z1 thereby locking the central adjustment belt 36. By actuating a release section (not shown) of the belt fastening device 38, the locking of the central adjustment belt 36 is cancelled and movement against the direction of arrow Z1 is enabled.

FIGS. 9a-9h schematically illustrate further embodiments of the deflection device (deflection element) 24, which can be formed separately and/or integrally with the upper cross brace 19 of the frame of the back section 16.

In FIG. 9a, the deflection device (deflection element) 24 is formed integrally with the upper cross brace 19 in such a way that the upper cross brace 19 forms a recess 26 in which a belt can be guided.

In FIG. 9b, the deflection device (deflection element) 24 is formed integrally with the upper cross brace 19 in such a way that the upper cross brace 19 forms two elevations 25 between which a belt can be guided.

In FIG. 9c, the deflection device (deflection element) 24 is formed separately from the upper cross brace 19 and attached to it in such a way that two elevations 25 and a recess 26 located between the two elevations 25 are formed, through which a belt can be guided.

In FIG. 9d, the deflection device (deflection element) 24 is formed integrally with the upper cross brace 19 in such a way that the upper cross brace 19 has a recess clearance 39 through which a belt can be guided.

In FIG. 9e, the deflection device (deflection element) 24 is formed separately from the upper cross brace 19 and attached to it in such a way that a recess clearance 39 is formed between the upper cross brace 19 and the deflection device (deflection element) 24, through which a belt can be guided.

In FIG. 9f, the deflection device (deflection element) 24 is formed separately from the upper cross brace 19 and attached to it in such a way that the deflection device (deflection element) 24 itself has a recess clearance 39 through which a belt can be guided.

In FIG. 9g, the deflection device (deflection element) 24 is formed integrally with the upper cross brace 19 in such a way that the upper cross brace 19 forms a slot in which a belt can be guided and, if necessary, threaded in laterally.

In FIG. 9h, the deflection device (deflection element) 24 is formed integrally with the upper cross brace 19 in such a way that the upper cross brace 19 forms a slot in which a belt can be guided and, if necessary, threaded in from above.

FIGS. 10a-10h schematically illustrate further embodiments of the deflection device (deflection element) 24, which can be formed in an upper section 18 of the back section 16 separately from a plate-shaped element 40 and/or integrally with a plate-shaped element 40.

In FIG. 10a, the deflection device (deflection element) 24 is formed integrally with the plate-shaped element 40 such that the plate-shaped element forms a recess 26 in which a belt can be guided.

In FIG. 10b, the deflection device (deflection element) 24 is formed integrally with the plate-shaped element 40 in such a way that the plate-shaped element 40 forms two elevations 25 between which a belt can be guided.

In FIG. 10c, the deflection device (deflection element) 24 is formed separately from the plate-shaped element 40 and is attached to the latter in such a way that two elevations 25 and a recess 26 located between the elevations 25 are formed through which a belt can be guided.

In FIG. 10d, the deflection device (deflection element) 24 is formed integrally with the plate-shaped element 40 in such a way that the plate-shaped element 40 has a recess clearance 39 through which a belt can be guided.

In FIG. 10e, the deflection device (deflection element) 24 is formed separately from the plate-shaped element 40 and is attached to the latter in such a way that a recess clearance 39 is formed between the plate-shaped element 40 and the deflection device (deflection element) 24, through which a belt can be guided.

In FIG. 10f, the deflection device (deflection element) 24 is formed separately from the plate-shaped element 40 and is attached to the latter in such a way that the deflection device (deflection element) 24 itself has a recess clearance 39 through which a belt can be guided.

In FIG. 10g, the deflection device (deflection element) 24 is formed integrally with the plate-shaped element 40 in such a way that the upper cross brace 19 forms a slot in which a belt can be guided and, if necessary, threaded in laterally.

In FIG. 10h, the deflection device (deflection element) 24 is formed integrally with the plate-shaped element 40 in such a way that the upper cross brace 19 forms a slot in which a belt can be guided and, if necessary, threaded in from above.

Combinations of the abovementioned embodiments are also conceivable and in accordance with the invention.

At this point, it should be noted that all the parts described above are claimed to be further developments of the invention when viewed in isolation and in any combination, in particular the details shown in the drawings. Modifications thereof are possible.

At this point, it should also be noted that all the parts or features described above each on their own—even without features additionally described in the respective context, even if these have not been explicitly identified individually as optional features in the respective context, e.g. by using: in particular, preferably, for example, e.g., optionally, round brackets, etc.—or in combination or any sub-combination are to be regarded as independent embodiments or further developments of the invention, as defined in particular in the introduction to the description as well as the claims. Deviations from this are possible. Specifically, it should be noted that the words in particular or round brackets are intended to explicitly characterise non-mandatory features in the respective context.

Finally, it should be noted that the present application for an industrial property right (in the event of registration or grant: the present industrial property right) aims for the broadest possible scope of protection of the invention. It is requested that this be borne in mind when reading, in particular in so far as (intermediate) generalisations of explicitly disclosed features or combinations of features are concerned.

### REFERENCE SIGNS

10 pram
11 frame
12 fastening option
13 seat unit
14 seat section
15 opening
16 back section (backrest section)
17 lower section
18u upper section
19 upper cross brace
20 joints
21 accommodation space
22 guide section (deflection point)
23 (further) guide section (deflection point)
24 deflection device (deflection element)
25 elevation
26 recess (clearance)
27 textile element (fabric cover)
28 belt system
29 lap belt
30 shoulder belt
31 combined shoulder-lap belt
32 crotch belt
33 belt buckle
34 connecting element
35 guide
36 central adjustment belt
37 actuating section
38 belt fastening device
39 recess clearance
40 plate-shaped element
α angle of the guide
L length
L1 length
L2 length
Z1 arrow direction
X1 axis

1. A child-accommodation device, in particular a pram and/or child seat, for mounting on a pram frame,
wherein the child-accommodation device has a seat unit and a belt system,
wherein the seat unit has a seat section and a back section which is adjustable relative to the seat section with regard to its inclination,
wherein the belt system is assigned at least one compensation device which is configured in such a way that at least one extension of at least one belt section between two deflection points or a deflection point and a fastening point is at least partially compensated for by a corresponding shortening of a further belt section between two deflection points or a deflection point and a fastening point when the inclination is changed.

2. The child-accommodation device, in particular a pram and/or child seat, for mounting on a pram frame, according to claim 1,
wherein the child-accommodation device has a seat unit and a belt system,
wherein the seat unit has a seat section and a back section which is adjustable relative to the seat section with regard to its inclination,
wherein at least one belt of the belt system is deflected at at least one deflection device, wherein, when the belt system is adjusted, a contact section of the at least one belt coming into contact with the deflection device can be guided over the deflection device at least essentially without resistance or with at least reduced resistance.

3. The child-accommodation device, in particular a pram and/or child seat, for mounting on a pram frame, according to claim 1,
wherein the child-accommodation device has a seat unit and a belt system,
wherein the seat unit has a seat section and a back section which is adjustable relative to the seat section with regard to its inclination,
wherein at least one belt of the belt system is deflected at at least one deflection device, wherein the deflection device is at least partially formed by a rod, of a frame part.

4. The child-accommodation device, in particular a pram and/or child seat, for mounting on a pram frame, according to claim 1,
wherein the child-accommodation device has a seat unit and a belt system,
wherein the seat unit has a seat section and a back section which is adjustable relative to the seat section with regard to its inclination,
wherein at least one belt of the belt system is deflected at at least one deflection device, wherein the deflection device defines a clearance which has a contact surface which comes into contact with the belt, wherein the clearance is at least partially covered by a fabric cover.

5. The child-accommodation device, in particular a pram and/or child seat, for mounting on a pram frame, according to claim 1,
wherein the child-accommodation device has a seat unit and a belt system,
wherein the seat unit has a seat section and a back section which is adjustable relative to the seat section with regard to its inclination,
wherein a fastening point for a crotch belt is connected in a fixed position to a back section or is arranged at a lower section of a back section or when spread:
rotates with the back section or
displaces forward relative to the seat section or
displaces upwards relative to the seat section.

6. The child-accommodation device according to claim 1,
wherein
the compensation device forms at least one first deflection point, which is arranged between a second and a third deflection point or is arranged between a second deflection point and a fastening point, wherein the first deflection point displaces relative to the back section or seat section when the back section and seat section are spread in such a way that a length of the belt between the second and third deflection points or a path of the belt between the second deflection point and the fastening point is shortened, wherein applies:
the first or second deflection point is designed in such a way that, when the inclination is adjusted, it rotates together with the back section or rotates together with the seat section, in particular is mounted in a fixed position relative to the back section or the seat section, or
the third deflection point or the fastening point is designed in such a way that, when the inclination is adjusted, it rotates together with the seat section or rotates together with the back section, in particular is mounted in a fixed position relative to the back section or the seat section.

7. The child-accommodation device according to claim 1,
wherein
at least one deflection point, which rotates with the back section during an inclination adjustment, lies below a level of an inclination axis at least in one configuration of the child-accommodation device or approaches the level of the inclination axis when the seat section and back section are spread or displaces upwards or forward relative to the seat section or moves away from a vertical left-right plane in which an/the inclination axis lies.

8. The child-accommodation device according to claim 1,
wherein
at least one deflection point, which rotates with the seat section during an inclination adjustment, lies behind an/the axis of inclination at least in one configuration of the child-accommodation device or displaces forward relative to an upper end of the back section when the seat and back sections are spread or displaces downwards relative to a lower end of the back section or has a constant distance of greater than or equal to 0 cm from the level of an axis of inclination.

9. The child-accommodation device according to claim 1,
wherein
a fastening point for a/the crotch belt and a deflection point for at least one shoulder belt coincide at least essentially in at least one projection onto a vertical front-rear plane.

10. The child-accommodation device according to claim 2,
wherein
a coefficient of static friction between a material of the contact section and a material of the deflection device is less than or equal to 0.5 or
a coefficient of sliding friction between a material of the contact section and a material of the deflection device is less than or equal to 0.4.

11. The child-accommodation device according to claim 2,
wherein
a surface of the deflection device comprises a thermoplastic, such as ABS, PA, PE or PP.

12. The child-accommodation device according to claim 2,
wherein
the deflection device comprises at least one deflection roll.

13. The child-accommodation device according to claim 3,
wherein
the belt does not come into contact with a/the fabric cover in the region of the deflection.

14. The child-accommodation device according to claim 1,
wherein
the belt system is configured as a 5-point belt or as a 3-point belt or is configured as a one-pull harness.
